(19) United States
(12) Patent Application Publication
(10) Pub. No.: US 2016/0161820 A1
(43) Pub. Date: Jun. 9, 2016

(54) WINDOW BLIND

(71) Applicant: HJ Forever Patents B.V., Rotterdam (NL)

(72) Inventor: Henricus Johannes Amesz, Rotterdam (NL)

(21) Appl. No.: 15/044,863

(22) Filed: Feb. 16, 2016

Related U.S. Application Data
(63) Continuation of application No. PCT/NL2014/050558, filed on Aug. 13, 2014.

(30) Foreign Application Priority Data
Aug. 13, 2013 (NL) 2011297

(51) Int. Cl. G02F 1/167; A01G 9/22; E06B 9/24; G02F 1/133

(52) U.S. Cl. CPC G02F 1/167; G02F 1/13306; A01G 9/22; E06B 9/24; G02F 2001/1678; G02F 2001/1676; E06B 2009/2464

(57) ABSTRACT

An optical transparent window blind comprising an electronic display device, having pixels, and uses thereof, such as use of the window blind for manipulating light, and use of said window blind in a green house. In a preferred embodiment the present window blind comprises an electrophoretic display device.

### CROSS-REFERENCE TO RELATED APPLICATIONS

This application is a continuation of International Application PCT/NL2014/050558 A1, entitled “WINDOW BLIND”, to HJ Patents B.V., filed on Jun. 24, 2014, which is a continuation to Netherlands Patent Application with Serial No. 2011297, filed 13 Aug. 2013, and the specification and claims thereof are incorporated herein by reference. The applications are legally transferred to HJ Forever Patents B.V.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention is in the field of an optical transparent window blind comprising an electronic display device, having pixels, and uses thereof, such as use of the window blind for manipulating light, and use of said window blind in a greenhouse and in a building. The present window blind comprises an electrophoretic display device.

2. Description of Related Art

Electronic display devices and especially electrophoretic display devices are a relatively new technique of pixilated display devices in which charged pigment particles are moved to generate a required pigmentation of a pixel.

For further details of present developments in this field as well as for drawbacks of the present technology reference is made to recently filed NL2010936, which reference is incorporated herein by explicit reference. Some details are provided below.

A benefit of the in-plane switching of charged particles is that the electrophoretic display device may comprise a transparent state, allowing a choice of reflector or possibly backlight.

However, in an electrophoretic display it is relatively difficult to control the electrical field and particle motion distribution accurately enough to provide a homogenous pixel absorbance in the “dark” state. Also stabilizing the dark and bright state, that is having particles being either present in a visible status or non-visible status, has not been solved properly for electrophoretic displays.

Also switching from a first state to a second state in the above display may be relatively slow; typically too slow for many applications, even with recently improved devices. It is noted that typically prior art particles move at a speed of less than about 1 mm per second, which is considered at least ten times too slow for certain applications.

It is noted that some major companies developing displays have stopped to develop electrophoretic displays, being discouraged by negative results, complexity of the technology, and lack of prospect. For similar reason, providers of pigmented particles had stopped further development as well.

Use and practical applications of the above electronic displays are so far limited, typically to relatively expensive devices.

Incidentally document JP H05 79669 U recites a window screen having an optically transparent screen having an electronic display.

Document U.S. Pat. No. 4,887,890 A recites a pane or foil with controllable transparency and light transmission which comprises a layer configuration between two transparent carriers such as glass panes, foils or the like; transparent electrodes are disposed on the carriers; a transparent electrolyte and an active polymer layer are disposed between the electrodes; the active polymer layer has light absorption in the visible spectrum range characterized by a variation in the case of a reversible chemical doping reaction; preferably an additional transparent layer is included to serve as reversible source for storage and yielding of ions, the additional layer is juxtaposed to the electrolyte.

Document US2012/182308 A1 recites a brightness control device. The brightness control device includes an electric paper, a controller, a light sensor, and a memory device. The electric paper includes a plurality of pixels. The light sensor is used to sense intensity of surrounding light. The memory device is coupled to the controller and used to store control programs and light data. The controller is coupled to the electric paper and the light sensor. The controller is used to control the pixels of the electric paper to determine the transparency of the electric paper according to the intensity of surrounding light and manually control signals by employing an e-paper control method.

The above mentioned three patent documents do not provide a solution to all or most of the present problems, unfortunately.

Prior art window blinds are made with slats of fabric, wood, plastic or metal that adjust by rotating from an open position to a closed position by allowing slats to overlap. A window blind is also known as a window shade. There are also window blinds that use a single piece of material instead of slats. The term window blinds is also sometimes used to describe the window coverings generically in this context window blinds include almost every type of window covering, i.e. shutters, roller blinds, honeycomb shades, wood blinds, roman blinds and of course, standard vertical and horizontal blinds. The window blinds may be used outside of the house or business to protect against theft, temperature, vision, bad weather, and fire. These window blinds occupy a relatively large space and are relatively thick. Even when not closed, these blinds are still visible. Typically they are difficult to attach to existing windows. Also blinds may be relatively dangerous; in the last decades many people, especially children, have died due to e.g. strangulation. Blinds are typically not fully adaptable to light conditions; typical systems basically have two settings: a position with a “total” block of light entering, and an open position. Going from a first to a second position is also rather slow.

Prior art blinds may come in various appearances, but once attached to a window only one of these appearances (the one bought by a customer) is left. So no further variations are possible (except for fully changing a first blind with a second blind).

Prior art window blinds are also relatively expensive.

Prior art window blinds can often not be operated from a practical point of view, such as in green houses. These blinds hinder working staff.

A further problem is that in areas with abundant sunshine typically glass windows and facades have a transmittance of light as low as possible, such as less than 30% and often less than 10%, typically having in mind that energy costs for cooling are preferably as low as possible. The transmittance is chosen once and can thereafter not be varied. The consequence hereof is that at full daylight the sun looks like the moon, the building becomes unattractive to live in, due to an uncomfortable feeling, having a light intensity of less than 100 Lux when the sun is more or less perpendicular to the window/facade and a fraction thereof if not, and at night or cloudy days hardly any outside light enters the building, placing the rooms/offices of the building in virtual dark.

It is an objective of the present invention to overcome disadvantages of the prior art window blinds without jeopardizing functionality and advantages.

### BRIEF SUMMARY OF THE INVENTION

The present invention relates in a first aspect to a window blind according to claim 1, and in a second aspect to use of a window blind.

In view of the present electrophoretic display device it is noted that a pixel thereof comprises an enclosed space, having a liquid and pigment particles. The pigment particles are allowed to move freely throughout the space, typically in a horizontal direction. The space (or pixel) typically is in the order of 50-500 μm. Upon applying an electro-magnetic field the pigment particles move through the liquid, from a storage area to an aperture area, and vice versa. In the storage area the particles are hidden from a viewer. E-ink technology, such as of US2002/167500 A1, is a different technology. Pigment particles can not freely move, as they are enclosed in microcapsules. Also pigment particles are relatively large, typically larger than 500 nm (0.5 μm), and on average 1 μm or larger. Upon applying an electric field negatively charged black particles may move from a light state to a dark state, that is from a bottom to a top of the microcapsule, i.e. in a vertical direction. In the light state the black particles are not visible because white particles are in their view path, whereas in the dark state the black particles are in the view path of the black particles. The microcapsules are relatively small (50 μm or less). It is noted that despite claims colored particles are simply not available for the E-ink technology. Only by applying a color filter a color may be provided. At best such relates to a very limited number of colors, and certainly not to full color displays. E-ink, is however at present much more “bi-stable” (black-white) than the present electrophoretic displays (visible versus hidden); it is also is capable of much faster switching between the bi-stable states. E-ink has as (further) disadvantage that is relatively difficult to produce, production is expensive, and production yield is too low (too much fracture, too much waste).

The present invention relies partly on earlier research and development by IRX Technologies B. V. For that reason and for better understanding of the underlying technology reference is made to recently filed (Jun. 7, 2013) Dutch Patent application NL2010936. Various aspects, examples, advantages and so forth are in principle one to one applicable to the present invention. The teachings and examples of the above document are incorporated by reference herein. It is noted that the technology disclosed in the above patent applications has not been put into practice yet. Various obstacles have been encountered that still had to be solved. For instance bi-stability and switching times were not according to standards. Various other aspects, examples, advantages and so forth are in principle one to one applicable to the present invention. The teachings and examples of the above document are incorporated by reference herein. The present invention provides amongst others an improved layout in view of the prior art.

An important advantage of the present pixel and display device is that they may be visible in full sunlight and hence block light. In an example the present particles are partly or fully reflective for at least a major part of the wavelengths in visible light as well as in IR-light.

The term “optical” may relate to wavelengths visible to a human eye (about 380 nm-about 750 nm), where applicable, and may relate to a broader range of wavelengths, including (infrared (about 750 nm-1 mm) and ultraviolet (about 10 nm-380 nm), and sub-selections thereof, where applicable.

Even further the present pixel and device are fully adaptable, e.g. to changing light conditions. It is an advantage that the present window blind can be fully transparent, e.g. under low light intensity conditions, and can be largely not transparent, e.g. under high light intensity conditions. Even further by adapting the present window blind to typical light conditions, e.g. low light intensity conditions in northern parts of the northern hemisphere, light may be allowed to enter to a large extent, and likewise may not be allowed to enter to a large extent.

The present invention provides an optical transparent window blind comprising an electronic display device. The electronic display device comprises pixels therein, which pixels can be changed instantly, i.e. within a few milliseconds. For the present window blind a somewhat slower change is also considered, i.e. within 10 seconds, preferably within 3 seconds. As such an appearance of the present window blind can be changed “instantly” if required, e.g. upon changing light conditions. Likewise, the present window blind may be changed when required or when instructed. When referring to dimensions of the present window blind a width relates to a largest dimension thereof. In an example the present window blind has a width of larger than 20 cm, such as from 50-500 cm, a height of 10-250 cm, such as 20-75 cm, and a thickness of 0.3 cm-10 cm, such as 1-5cm.

By fully integrating the display device into a window a risk of suffocation and strangulation is absent. As the present display device consumes a low amount of energy (power), and an electrical part thereof is relatively safe.

An important advantage of the present pixel and device is that they can be read in full sunlight.

Even further the present pixel and device are fully adaptable, e.g. to changing light conditions. As a result a large number of novel applications and uses come into sight.

The present invention also provides a device having information displayed therein, which information can be changed instantly. In principle the present display may be provided as a flexible display.

It has recently been found that charged particles do not remain in the storage area for a sufficiently long time. For prior art devices particles remain in a storage area during less than a few seconds, during which the aperture area is almost fully covered with particles, therewith deleting any image. In view thereof a restrictor is provided. As a result both the switching time and bi-stable time are acceptable. The switching time is below 1 second, typically below 500 mseconds, such as below 350 mseconds, whereas the bi-stable time is above 10 seconds, typically above 120 seconds. The present restrictor also overcomes a prior art need to totally refresh an image; such an image would disappear for about 0.5 seconds; with the present restrictor only fading needs to be compensated for. The present restrictor is preferably a switchable restrictor, i.e. it may be in an active state or in a passive state. The restrictor especially improves the bistable time by at least a factor, such by at least two times, and typically by at least ten times. Thereby the restrictor makes it possible to use the present pixels in many envisaged applications, whereas without the restrictor effectively the pixels can not be put into practical use, albeit at the expense of some limited power consumption.

In an example of the present pixel the restrictor is one or more of an electro-magnetic field of opposite character of the pigment particle charge provided in the storage area, an electro-magnetic field of same character of the pigment particle charge provided in the aperture area, a chemical changer of the pigment particles, a temperature sensitive gel, and a magnetic changer of the pigment particles. The electro-magnetic field may be provided at regular intervals, such as once every second during a few milliseconds, preferably at a limited rate, such as once every 10 seconds, or once every minute. The electro-magnetic field may be a direct field or an alternating field. In view of particles an alternating field may be preferred. Such depends a bit on a type of pigments used, the fluid used, etc. An advantage is that an image remains, to the human eye, relatively stable, especially as no need for a complete refresh of an image is required. The field may be an electrical field, such as a field of 0.25-48 V, preferably 0.3-24 V. Likewise a magnetic field can be applied. The restrictor may also relate to a chemical change of particles and/or fluid. Such a change can be established by e.g. an acid-base reaction, a temperature change, and a change in electro-magnetic field, thereby changing a charge of the pigment. As such the pigment particle may be coated with a compound, the compound being capable of the mentioned acid-base reaction. As an example of a temperature sensitive gel polyisocyanopeptides, grafted with oligo(ethylene glycol) side chains are mentioned. These gels are found to increase the viscosity with increasing temperature in a drastic fashion. Such a gel is especially advantageous when using the present pixels at an elevated temperature, such as a window blind. Also a change in magnetic properties may be used, such as caused by hysteresis, wherein the hysteresis is preferably semi-symmetrical with respect to a field applied.

The present device comprises a driver circuit for changing appearance of (individual) pixels by applying an electro-magnetic field. As such also appearance of the display device, or one or more parts thereof, may be changed.

The present device may further comprise a means for receiving data, such as individual pixel data, pixel color data, pixel filter data, pixel spectral data, pixel reflectivity data, pixel transmittance data, pixel intensity data, and display pattern data, etc. As such the present window blind can be controlled on a pixel level, on a display level, on a matrix of pixels level, and combinations thereof. In an example the present window blind can manipulate light in a block pattern mode, in a strip pattern mode, in an artistic pattern mode, and combinations thereof. It is noted that such a pattern can be created by a user independently or selected from an available set, and being provided by a user to the present window blind. As such a pattern may be changed when required, e.g. on a daily base, or never. As such a pattern may also be maintained over a period of time. It is preferred to provide data in a wireless mode; however data may also be provided by connecting a cable or the like, such as be providing a USB-port or the like. For the wireless mode preferably an RFID per display and/or window blind is provided, as well as a transmitter for communicating with the display, preferably a transceiver, for also receiving data from a display. As such each individual window blind and display can be adapted, e.g. according to wishes of a user, and to light conditions.

The present window blind may comprise a unique code for identification. As such every window blind can be identified individually. Likewise parts thereof may be identified. Each window blind can thus be operated separately and together, as required. Each window blind or part thereof may as a result also be maintained individually.

In principle the present window blind may comprise one display device. Likewise a number of display devices can be adapted to specific conditions and requirements. A display device may cover a certain area of a window blind, or a total area thereof. A window blind may also comprise a first display device on a first side thereof, and a second display device on a second side thereof. A window blind may also comprise more than one display devices on one side thereof. Also combinations of the foregoing are possible.

The present display device is relatively thin and can therefore in principle be applied to any window blind. The display present has a thickness <0.1 cm, preferably a thickness of 2 μm-500 μm, more preferably a thickness of 3 μm-300 μm, even more preferably a thickness of 5 μm-200 μm, such as 10 μm-100 μm. A thickness may vary, e.g. depending on a number of devices applied. As such the present display device (in a transparent mode) is not or hardly visible for a human eye.

It is a further advantage of the present invention that the window blind may be used both as a screen and an image forming entity.

Thereby the present invention provides a solution to one or more of the above mentioned problems.

Advantages of the present description are detailed throughout the description.

### DETAILED DESCRIPTION OF THE INVENTION

The present invention relates in a first aspect to a window blind according to claim 1.

In an example the present device comprises one or more of a means for storing data, such as a memory, such as RAM, a ROM, a flash memory, etc. Typically a memory of 0.1 GByte-50 Gbyte per display is provided, depending on a size of the display and pixel size. The device may further comprise a means for processing data, such as a CPU, for making received data visible, for addressing individual pixels, for refreshing a display, etc. As such the appearance/transmittance of the window blind or part thereof may change over time and even instantly. Such could be attractive, e.g. in view of expectations of a viewer/user. The device may further comprise a means for near field communication, such as a receiver and a transmitter. As such a display device may directly be addressed using a suitable signal, the signal providing updated information. Typically such communication also involves hand-shaking protocols, such as identifying an ID of a device and e.g. a computer or the like providing further information.

It is noted that by providing (wireless) signals like all display devices may be updated within a small time frame, if required. Such can be repeated e.g. every hour, or every minute, or every second. In fact continuous communication between device and information providing means, such as a computer, may be continuous. As such performance of the present window blind may be adapted (almost) continuously.

As the present device and in particular an electrophoretic display device consumes a minute amount of energy a small means of providing power, such as a battery, a capacitor, a coil, etc. may be provided. It is noted that power consumption of the present device is so low that the display needs to be refreshed at the most only every two hours.

The present device may in an example comprise a controller, such as a chip, a CPU. The controller, driver, power supply, means for transmitting and receiving may be integrated.

In an example the present window bind comprises at least two optical parallel transparent screens, such as glass, having a space in between a first and second optical transparent screens, preferably an enclosed spaced, wherein the window blind has an outer side transparent screen, wherein the display device is located on the outer side screen, such as on an inside or outside of the outer side screen. In an example more than one display may be provided, wherein the displays may be stacked, may be place on various locations on the present screen, such as one inside and one outside, etc. If a present device is placed on an outside of the window blind, a protective layer or coating may be provided. Typically the present devices may already have an outer layer, the outer layer also functioning to protect the device.

Depending on production techniques the present device may be located on an inside or outside location of the present window blind. In an example it is preferred to first produce a window blind per se, and then combine the window blind with the present display device, such as by adhering the present device to the window. As the present device may be flexible, adhering can be performed by an adhesive. Such may be done by providing the device as a roll-on roll off polymer, that may be attached to a glass surface, e.g. by slightly heating and stretching. At the same time connections can be made, e.g. being accessible to a power grid.

In an example the present window blind comprises one or more of a means for switching the display on and off. The switch allows for example to switch between a transparent state of the present window blind and a (largely) non-transparent state thereof. The switch may provide a transition from a first to a second setting of the present window blind.

In an example appearance and function of the present window blind may change periodically, or even semi-continuous.

In an example a means for providing power is provided, such as a battery. Likewise the present window blind may be connected to a power grid.

In an example the present window blind may vary light and/or frequency conditions, on a real time basis, based on programmed conditions, based on measurements, based on requirements, based on input from a user, and combinations thereof. In an example a controller for changing reflectivity is provided; therewith a certain amount of light may be reflected. In an example a controller for changing transmittance is provided; therewith a certain amount of light may be transmitted. In an example a spectral filter is provided; for instance in case of a green house, or in case of extreme light conditions, certain wavelengths may pass and certain wavelengths are blocked. E.g. for a similar reason in an example a spectral band filter is provided. In an example a frequency modulator is provided; such could be useful in cases where one or more frequencies are preferred, e.g. for growth conditions, but are in a limited amount available, by using a modulator such frequencies can be made more available. In an example a spectral intensity controller is provided; for instance, in some cases some frequencies are not or less preferred, and can as such be filter out, whereas other frequencies are more preferred, and can as such be allowed to pass. In an example an IR-reflector is provided; especially under cold conditions it may be required to maintain radiation inside. In an example a polarizer is provided; by providing a polarizer various optical processed become available. Likewise, in an example an analyser is provided. In an example a sensor for detecting light and spectral intensity is provided; as such control thereof is provided. In an example a controller is provided, such as a chip. The controller may provide one function, of various functions. The controller may control on a real-time basis, may control on a periodic basis, may control when instructed, e.g. by a user, may control when receiving input from another device, such as a sensor, and combinations thereof.

In an example the present device comprises an electrophoretic display, or may be selected from an electrophoretic display, and an LCD and/or a LED-display. In view of e.g. energy consumption, resolution, and visibility, an electrophoretic display is preferred. However, if also actively light needs to be provided a LED-display may be included as well, such as for a green house.

In an example the present electrophoretic display device comprises sophisticated pixels, the pixels comprising at least one aperture area being visible. The present pixel can be switched relatively quick, in the order of (a few) milliseconds, which is considered fast enough for most applications. The present pixel comprises an aperture, for allowing passage of light, in principle into and out of the pixel. It is noted that a pixel is confined by e.g. an upper transparent glass plate, protecting the pixel from the environment. The upper part is visible to a user. Part of the upper part relates to an aperture area. The aperture area may comprise further optical elements, such as a lens, e.g. a Fresnel lens, a prism, etc. Another part comprises further functional elements of the pixel, typically (intentionally) not transparent to light.

The pixel comprises a fluid (or liquid). The fluid may be any suitable fluid and a combination of suitable fluids. It is preferred to use a relatively low viscosity fluid, such as having a dynamic viscosity of 1 mPa·s or less. The fluid comprises at least one type of pigment particles having a diameter smaller than 500 nm. It has been found that these particles provide a good distribution of particles over the present (field) electrode. In view of an electro-magnetic field to be applied the present particles are being chargeable or charged. Likewise magnetic particles may be used. A small charge per particle is found to be sufficient, such as from 0.1 e to 10 e per particle. A concentration of particles is in the order of 1-100 g/l. A size of an electric potential is in the order of 0.5-50 V, preferably from 1-20 V, such as 5-15 V. For the present pixel a relatively large potential is preferred, e.g. 15-10 V. It has been found that fluid behaviour is better at a higher voltage, e.g. in terms of flow, and switching time. It is preferred to have particles charge stabilized. As such a better performance e.g. in view of distribution over the field electrode, and faster and better controllable switching times are achieved.

The pixel further comprises at least two electrodes spaced apart for providing an electric-magnetic field, of which at least one electrode is an accumulation electrode and at least one electrode is a field electrode. The accumulation electrode accumulates particles when these are intended not to be visible, whereas the field electrode attracts particles when these are intended to be visible. As a consequence the at least one field electrode occupies a field electrode area, the field electrode area and aperture area largely coinciding. One electrode may relate to an electrically neutral for ground) electrode. It is noted that the terms “accumulation” and “field” relate to a function intended by the respective electrodes.

In an example a thin-film transistor is applied to drive a pixel, optionally in combination with other drivers.

Further the pixel comprises at least one storage area for storing the at least one type of pigment particles out of sight. As a consequence the at least one storage area is adjacent to the at least one aperture area.

For improved performance, e.g. in terms of switching time, distribution of particles, durability, etc. it is preferred to have at least two accumulation electrodes and at least two field electrodes, more preferably at least one of each electrode located at a side of the pixel.

As mentioned above the present pixel may be relatively small. For certain applications, e.g. outside window blinds, green houses, etc. where e.g. switching times are less critical, relatively large pixels may be used, such as having a length of up to 5000 μm. For housing a length of up to 1000 μm is preferred. When switching times become more critical smaller pixels are preferred having a length of the pixel being smaller than 250 μm, preferably smaller than 150 μm, more preferably smaller than 100 μm, such as smaller than 90 μm. Present designs relate to a length of 150 μm, of 85 μm, of 75 μm, and of 50 μm. A smallest size considered at this point in time is about 25 μm. Also combinations of sizes are envisaged; such could imply a standardized unit length of e.g. 75 μm is used, and multiplicities thereof. From a production point of view somewhat larger pixels are preferred, such as having a length of 300 μm-500 μm. From a control point of view smaller pixels are preferred. Typically a width of the pixel has a similar or the same dimension. The present pixel now provides an optical resolution that is more than sufficient for any application considered at this point in time. In an example maps may be provided on a smartphone, having sufficient optical detail to find ones way. Further a reader can continue reading for a long period of time, without getting tired. It is noted that in this respect LCD-displays provide too much light.

It has been found that in view of switching times a size of the pixel needed to be much smaller than was available by prior art techniques (some 300 μm). Unexpectedly the switching time decreased dramatically (non-linear).

In an example of the present pixel the fluid carries a charge. Such has been found to particularly advantageous, in similar terms as mentioned above.

It has been found that a disadvantage of the present pixels, and especially of smaller pixels, is that an electrical breakdown may occur. In order to prevent such a breakdown further measures may be incorporated. In an example the fluid has a reduced permittivity εᵣ of less than 10, preferably of less than 5. However, such change in permittivity typically involves further compounds, such as oils, which are not (fully) compatible with other constituents. Thereto further compounds/components may be added, such as a surfactant, an emulsifier, a polar compound, and a compound capable of forming a hydrogen bond. In view of relatively quick switching times it has been found that the viscosity of the fluid is preferably less than 0.1 Pa*s, such as by using a mixture comprising ethylene glycol.

In an example the present pixel has a rectangular shape, such as a square shape, or a hexagonal shape. In view of switching times these layouts have been found to perform optimally. The hexagonal shape has a further advantage in that each side of the hexagon may be used for accumulating pigment particles. By varying charges or otherwise a first side can be used for red particles, a second side for green particles, and a third side for blue particles, and so further. Such could also be achieved by sub-dividing at least one side of a square pixel.

In an example of the present pixel the at least one type of pigment particles comprise one or more of white particles, red particles, green particles, blue particles, black particles, reflective particles, light absorbing particles, fluorescent particles, and phosphorescing particles. As such a combination of visible pigment particles may be provided, thereby obtaining any intended colour, in any intended brightness. In principle the same effect could be obtained by using one or more pigment particles that absorb (a specific wavelength (region) of) light. Likewise also reflective pigments may be used. The present small pixel size makes it possible to make e.g. in a matrix format a red pixel, adjacent to a blue pixel, adjacent to a green pixel, etc. As such a mixture of colours may be provided by activating an intended pixel, in an intended intensity, etc.

In an example of the present pixel each type of pigment particle carries a significantly different charge, such as one being charged positively, another negatively, a third with a small charge, and a fourth with a large charge, etc. In an example the charge is from 5*10⁻⁷-0.1 C/m², such as from 1*10⁻⁵-0.01 C/m². In an example the present pigment may change colour or appearance upon applying an electro-magnetic field, or likewise upon removing such a field.

In an example of the present pixel the pigment particles are smaller than 400 nm, preferably smaller than 100 nm, typically larger than 10 nm. In view of performance, switching times, distribution, etc. the above sizes are found to be optimal. It is preferred to provide a stable dispersion; as such the above sizes are preferred. The particle size is considered to be a measure of an averaged diameter thereof.

In an example the present fluid is provided in an amount of 1-100 gr/m², preferably 2-75 gr/m², more preferably 20-50 gr/m², such as 30-40 gr/m², and the present pigments are provided in an amount of 0.02-30 gr/m², preferably 0.05-10 gr/m², more preferably 0.5-5 gr/m², such as 1-3 gr/m².

In an example the present pixel further comprises a UV-filter. Such is not considered yet, however, inventors have identified that some of the elements inside a pixel and possibly a transparent layer are preferably protected from environmental effects, such as UV-light. In an example especially an electrode needs to be protected from UV-light.

In an example of the present pixel the aperture area is more than 90% transparent, preferably more than 95%. The aperture area may be made of glass and a suitable polymer, such as poly carbonate (Perspex). The material for the aperture, e.g. glass, may have a thickness of 0.2 μm-2 mm. If a flexible pixel and/or display are required it is preferred to use a thin material. If some strength is required, a thicker material is preferred. It has been found that with such transparency energy consumption can even be further reduced. In this respect it is noted that the present pixel uses about 0.1% of prior art pixels, such as LCD-pixels. Such provides have advantages, e.g. in terms of usage, reduced need for loading devices, smaller charge storing devices, etc. Especially when a power grid is not available such will be appreciated. It is noted that power consumption of e.g. smartphones is significant. Any reduction in power consumption will be beneficial to the earth.

In an example of the present pixel the aperture area is less than 75% transparent, preferably less than 50%. Such may especially be beneficial in areas with abundant (sun) light available. Inherently the pixel functions as a light filter.

In an example of the present pixel the at least one field electrode is at least partly transparent to visible light, preferably more than 95% transparent. In an example an upper electrode, e.g. in a stack of pixels, is preferably as transparent as possible. In a further example the at least one field electrode is at least partly reflective to visible light, preferably more than 95% reflective, such as when forming a “bottom” electrode, such as in a lowest pixel in a stack. Also combination of the above is envisaged.

In an example the present window blind comprises a photovoltaic layer. The layer may be present as a separate layer, such as an overlay in the present display device, a layer on a side of the present window blind, or may be fully integrated, e.g. within the present pixel. If a photo-voltaic layer is present a need for a power supply of the present device may be absent altogether.

In an example the present pixel comprises one or more vortices in a plane of the pixel, wherein the one or more vortices have a dimension in the order of 0.8-1.2 times a pixel diameter, preferably 0.9-1.1 times a diameter. Such allows an improved liquid flow onto and from a pixel electrode.

In an example the present pixel comprises a pumping area, the pumping area preferably having a width of 0.1-0.3 a width of a pixel, and a length of 0.1-0.4 times a width of a storage area Such provides both a small electrode distance with a high field, and exerts a high force upon the particles and fluid, and therefore induces a strong electro-osmotic flow onto the pixel electrode, and into a wider escape area next to it, which allows the liquid to leave the pixel again in a different direction.

In an example a stack of present pixels is envisaged comprising at least two pixels according to the invention. In an example three pixels may be stacked, such as a red pigment comprising pixel, a green pigment comprising pixel, and a blue pigment comprising pixel. In an example a fully reflective pixel may be present in a first layer, coloured pigments in a second layer, and black and white pixels in a third layer. As such any combination of layers, and pigments therein, may be possible.

In an example the present electrophoretic display device further comprises a driver circuit for driving the one or more pixels by providing an electro-magnetic field, typically an electrical field. The applied voltage is in an example 15-30 V, preferably being large enough to move particles. Preferably counter ions are present.

In an example the electrophoretic display device comprises at least one shared field electrode. The shared field electrode may be shared by at least two pixels, typically by a row or column of pixels.

The present driver circuit for use in an electrophoretic display device according to the invention or in a pixel according to the invention, may comprise a means for providing a time varying electro-magnetic field between the at least one field electrode and the at least one accumulation electrode. Therewith movement from charged pigment particles to and from an accumulation electrode and from and to a field electrode is effected. The driver circuit may further provide an electro-magnetic field for clearing pixels (removing charged particles), for driving pixels (introducing charged particles), for resetting pixels (moving charged particles to an initial position), for applying a static charge, and for remaining charged pixels in position occupied at a point in time. Also a field for refreshing may be provided, e.g. for having a similar or same amount of pixels in an earlier position.

In an example the driver circuit comprises a switch for providing a static electro-magnetic field or charge to one or mare of the electrodes. In an example only very scarcely a static pulse, or likewise a refresh pulse is provided, such as once every two hours. The pulse may be short and at a low intensity.

In an example the electronic display comprising pixels is provided in a flexible polymer, and the remainder of the display device is provided in glass. The glass may be rigid glass or flexible glass. If required a protection layer is provided. If more than one colour is provided, more than one layer of flexible polymer may be provided. The polymer may be poly ethylene naphthalate (PEN), poly ethylene terephthalate (PET) (optionally having a SiN layer), poly ethylene (PE), etc.

In a further example the electronic display comprising pixels is provided in at least one flexible polymer. As such the display may be attached to any surface, such as by using an adhesive.

In a second aspect the present invention relates to a use of a window blind according to the invention, preferably an electrophoretic display device, for one or more of filtering light, reflecting light, reflecting heat, generating light, energy harvesting, and modulating light. As such a fully adaptable window blind is provided, being capable of manipulating light as required.

As a result of very low energy consumption relatively large window blinds now can be made in an economic fashion. The present resolution may be in the order of 300 DPI, or better. A size of the window blind may be relatively small such as from 10 cm² (or smaller), up to very large scale, e.g. 1000 m².

In an example the present window blind is used in a green house. In particular relevant frequencies can be provided to the plants inside a green house, by manipulating light entering the green house, and/or by further providing light, e.g. in dark circumstances, such as by a LED, the LED being adaptable in light frequencies generated. It is a further advantage that the present window blind can be operated fully automatically, and individually, therewith at any time providing required light conditions.

By providing e.g. UV-light appearance of color of flowers, fruits and vegetables can be improved.

By providing blue light photosynthesis can be improved, especially by stimulating formation of chlorophyll, development of chloroplasts, skin openings, production of certain enzymes, and a 24-hours cycle of photosynthesis and photomorphogenesis. Blue light is found to improve leaf production and limit a length of a stem.

Likewise, by providing red light (600-700 nm) photosynthesis can be improved, at a lower energy costs compared to blue light. Selectively filtering red light may limit formation of side shoots and lint.

By limiting light entering a blossom period can be extended and initiated, as desired. Likewise forming of plant extensions can be influenced.

Manipulation of an amount of near infrared and far infrared radiation may be used to control a temperature in a green house.

In an example the present window blind is used in a building, especially for a full sunlight application. Therewith light conditions inside can be managed and controlled at any point in time, taking into account heat influx and cooling. Thereto a controller, a light sensor inside and a light sensor outside, and a temperature sensor may be provided. Based on light influx the present blind may be put into a more, or less, transparent mode. In view of not blocking a vision to the outside world completely, the window blind may also be put in a raster mode, such as in a Louvre hatch pattern.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

The invention although described in detailed explanatory context may be best understood in conjunction with the accompanying examples and figures.

### SUMMARY OF FIGURES

FIGS. 1a and 1b show a worked open and side view of a layout of a window blind.

### DETAILED DESCRIPTION OF FIGURES

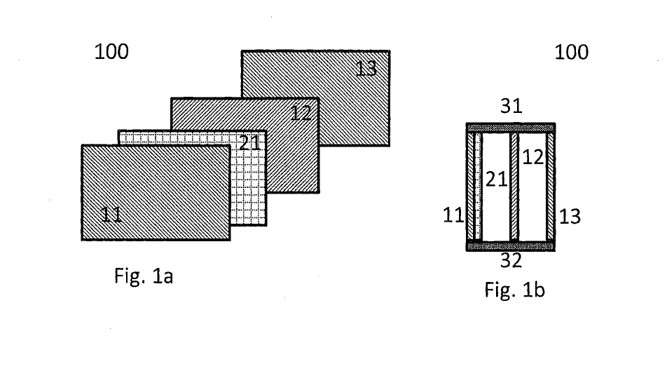

FIG. 1a shows a worked open view of an example of a layout of a window blind 100. Therein a sequence of elements is provided. A first glass screen 11, attached thereto a display device 21 according to the invention, an open space for providing thermal insulation (not indicated), a second glass screen 12, a (second) open space for providing thermal insulation (not indicated), and a third glass screen. 13.

FIG. 1b provides a side view of an example of the present window blind 100. Therein further a top and bottom element 31 and 32, respectively, are provided, such as a frame, for enclosing open spaces in between glass screen and fixing elements into place.

It should be appreciated that for commercial application it may be preferable to use one or more variations of the present system, which would similar be to the ones disclosed in the present application and are within the spirit of the invention.

What is claimed is:

1. A window blind comprising:
(i) at least one optical transparent screen, such as a glass panel, and
(ii) parallel to the screen, one or more display devices, the one or more display devices comprising an electrophoretic display comprising pixels,
the pixel comprising
at least one aperture area being visible,
a fluid comprising at least one type of pigment particles, the particles being chargeable or charged,
at least two electrodes spaced apart for providing an electric-magnetic field, of which at least one electrode is an accumulation electrode and at least one electrode is a field electrode, wherein the at least one field electrode occupies an field electrode area, the field electrode area and aperture area large coinciding,
at least one storage area for storing the at least one type of pigment particles out of sight, wherein the at least one storage area is adjacent to the at least one aperture area, and
a restrictor for maintaining pigment particles in the storage area, wherein the restrictor is at least one of an electro-magnetic field of opposite character of the pigment particle charge provided in the storage area, an electro-magnetic field of same character of the pigment particle charge provided in the aperture area, a temperature sensitive gel, a chemical changer of the pigment particles, and a magnetic changer of the pigment particles,
wherein a length of the pixel is smaller than 5000 μm,
a driver circuit for applying an electro-magnetic field to the pixels,
wherein the display device has a thickness <0.1 cm.

2. The window blind according to claim 1, wherein window blind comprises at least two optical parallel transparent screens, having a space in between a first and second optical transparent screens, wherein the window blind has an outer side transparent screen, wherein the display device is located on the outer side screen.

3. The window blind according to claim 1, further comprising at least one of a means for switching the display on and off, a means for providing power, a controller for changing reflectivity, a controller for changing transmittance, a spectral filter, a spectral band filter, a frequency modulator, an spectral intensity controller, an IR-reflector, a polarizer, an analyser, a sensor for detecting light intensity, a sensor for determining frequency intensity, and a controller.

4. The window blind according to claim 1, further comprising a means for receiving data,
a unique code for identification, and
wherein the display device has a thickness of 2 μm-500 μm.

5. The window blind according to claim 1, wherein pigment particles have a diameter smaller than 500 nm,
wherein a length of the pixel is smaller than 5000 μm.

6. The window blind according to claim 1, having at least one of
the fluid carrying a charge,
the pixel has a rectangular shape, such as a square shape, or a hexagonal shape,
the at least one type of pigment particles comprise one or more of white particles, red particles, green particles, blue particles, black particles, reflective particles, light absorbing particles, fluorescent particles, and phosphorescing particles,
each type of pigment particle carries a significantly different charge, the charge being from 5*10−7-0.1 C/m², the pigment particles are smaller than 400 nm, and larger than 10 nm
the pixel comprising a UV-filter,
wherein the aperture area is more than 90% transparent,
wherein the aperture area is less than 75% transparent,
a photo-voltaic layer,
the pixel comprising one or more vortices in a plane of the pixel, wherein the one or more vortices have a dimension in the order of 0.8-1.2 times a pixel diameter.

7. The window blind according to claim 1, wherein the at least one field electrode is at least partly transparent to visible light.

8. The window blind according to claim 1, wherein the at least one field electrode is at least partly reflective to visible light.

9. The window blind according to claim 1, wherein the fluid comprises at least one of a surfactant, an emulsifier, a polar compound, and a compound capable of forming a hydrogen bond,
the fluid has a relative permittivity εᵣ of less than 10, and a viscosity of less than 0.1 Pa*s,
the fluid is provided in an amount of 1-100 gr/m², and
the pigments are provided in an amount of 0.02-30 gr/m².

10. The window blind according to claim 1,
wherein the pixel comprises a pumping area, the pumping area having a width of 0.1-0.3 a width of a pixel, and a length of 0.1-0.4 times a width of a storage area.

11. The window blind according to claim 1, wherein the display device comprises a stack of pixels.

12. The window blind according to claim 1, comprising at least one shared field electrode.

13. The window blind according to claim 1 comprising a driver circuit, the driver circuit comprising a means for providing a time varying electro-magnetic field between the at least one field electrode and the at least one accumulation electrode.

14. The window blind according to claim 13, wherein the driver circuit comprises a switch for providing a static electro-magnetic field or charge to one or more of the electrodes.

15. The use of a window blind according to claim 1 for at least one of filtering light, reflecting light, reflecting heat, generating light, energy harvesting, and modulating light.

16. The use according to claim 15 in a green house, and in a building.

17. The use according to claim 15 for a full sunlight application.
